(19) United States
(12) Patent Application Publication
(10) Pub. No.: US 2006/0201253 A1
(43) Pub. Date: Sep. 14, 2006

(54) System for non-contact interrogation of railroad axles using laser-based ultrasonic inspection

(75) Inventors: Kari L. Gonzales, Pueblo, CO (US); Richard L. Morgan, Pueblo, CO (US); Shant Kenderian, Pasadena, CA (US); James R. Bilodeau, Loveland, CO (US)

Correspondence Address: DORR, CARSON & BIRNEY, P.C.;ONE CHERRY CENTER, 501 SOUTH CHERRY STREET, SUITE 800, DENVER, CO, 80246, US

(73) Assignee: Transportation Technology Center, Inc.

(21) Appl. No.: 11/374,344

(22) Filed: Mar. 13, 2006

Related U.S. Application Data
(60) Provisional application No. 60/661,571, filed on Mar. 14, 2005.

(51) Int. Cl. G01N 29/04

(52) U.S. Cl. 73/643

(57) ABSTRACT

A system for ultrasonic inspection of railroad axles uses a laser to project a series of pulses onto the axle to create an ultrasonic signal propagating along the surface of the axle. An air-coupled detector detects the ultrasonic signal at a position on the axle spaced apart from the laser impact region. The ultrasonic signal can then be analyzed to detect the presence of a reflected wave indicating the presence of a defect in the axle.

### RELATED APPLICATION

The present application is based on and claims priority to the Applicants' U.S. Provisional Patent Application 60/661,571, entitled “System for Non-Contact Interrogation of Railroad Axles Using Laser-Based Ultrasonic Inspection,” filed on Mar. 14, 2005.

### BACKGROUND OF THE INVENTION

1. Field of the Invention

The present invention relates generally to the field of ultrasonic inspection. More specifically, the present invention discloses a laser-based ultrasonic system inspection to detect cracks in railroad axles.

2. Statement of the Problem

Preliminary data, from the 2002 Federal Railroad Administration (FRA) Accident Data Base, shows that 12 train accidents were caused by freight car axles broken between the wheel seats and four accidents were caused by journal fractured, new cold breaks. Axle fatigue cracks present an important safety concern and a solution to this problem is a high priority for the rail industry.

Recent testing funded by the Association of American Railroads (AAR) Strategic Research Program indicate that axle strains are within the designed fatigue strength of the axle. However, localized stress and surface defect flaws may eventually begin to grow into fatigue cracks, which propagate and cause the axle to fail unless detected. In the axle body, stress risers, such as nicks and gouges, may be induced during handling of the axle. These stress concentration points appear to be the limiting factor in axle lifetimes. In order to decrease the threat of derailment associated with fatigue-induced axle failures, a method is needed to either eliminate stress risers or to detect fatigue cracks before they reach a critical length. Current nondestructive inspection (NDI) techniques available to the railroad industry require the removal of wheel sets in maintenance shops where inspections are performed on axles and wheels. These techniques also require contact or near-contact conditions between the tested wheel or axle and the inspection probe.

The laser air-coupled hybrid ultrasonic technique (LAHUT), a recent development in non-destructive testing (NDT), uses a non-contact laser ultrasonic technique to identify defects and flaws in metals and other materials. In particular, the LAHUT combines laser generation and air-coupled detection of ultrasound. It has the unique characteristic of interrogating a specimen while maintaining a significant distance between the inspection probe and the surface of the specimen. Laser generation apparatus can be several yards away from the interrogated surface while air-coupled detection standoff can be on the order of several inches. The technique also has the capability of interrogating structural materials in their true industrial environment. The application of the LAHUT methodologies to inspect railroad track has been described by Scalea, et al., Non-Contact Ultrasonic Inspection of Railroad Tracks, 45^{th} International SAMPE Symposium, May 21-25, 2000; Kenderian, et al., Point and Line Source Generation of Ultrasound for Inspection of Internal and Surface Flaws in Rail and Structural Materials, Research in Nondestructive Evaluation, vol. 13, no. 4, pp. 189-200, December, 2001; and Kenderian et al., Laser Based and Air Coupled Ultrasound as Noncontact and Remote Techniques for Testing of Railroad Tracks, Materials Evaluation, vol. 60, no. 1, pp. 65-70, January, 2002. Further, using LAHUT procedures to inspect rail car wheels has been discussed by Kenderian, et al., Laser/Air Hybrid Ultrasound Technique for Railroad Wheel Testing, Materials Evaluation, vol. 61, no. 4, pp. 505-511, April, 2003. However, the prior art has not applied this technology to the field of railroad axle inspection.

Solution to the Problem. The present invention is directed to the wayside inspection of moving railcar axles, identifying axles with unsafe cracks, and flagging them for removal prior to failure, so as to address the need of reducing the number of annual derailments from broken axles and of decreasing the associated derailment-related safety hazards.

### SUMMARY OF THE INVENTION

This invention provides a system for ultrasonic inspection of railroad axles. A laser projects a series of pulses onto the railroad axle to create an ultrasonic signal propagating along the surface of the axle. An air-coupled detector receives the ultrasonic signal at a position on the axle spaced apart from the laser impact line. The ultrasonic signal can then be analyzed for the presence of a reflected wave indicating the presence of a defect in the axle.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a diagram of one embodiment of the present invention.

FIG. 2 is a graph showing a sample signal for an axle with no crack.

FIG. 3 is a graph showing a sample signal for an axle with a crack.

FIG. 4(a) is a graph showing a sample signal for an axle with a crack positioned so that the time of flight (TOF) of the reflected wave is equal to the TOF of wave B.

FIG. 4(b) is a graph corresponding to 4(a) showing a signal for an axle without a crack.

FIGS. 5(a) and 5(b) are graphs showing close-ups of the circled portions of the signals in FIGS. 4(a) and 4(b), respectively.

FIGS. 6(a) and 6(b) are graphs of the power spectral density of the signals shown in FIGS. 5(a) and 5(b), respectively.

FIGS. 7(a)-7(d) are graphs showing signals for axles with, and without a crack, for two different separation distances between the crack and the laser impact line.

FIGS. 8(a) and 8(b) are graphs showing sample signals for a 3-inch net change in the separation distance between the crack and the laser impact line.

FIG. 9 is a diagram illustrating crack rotation through the laser sound field (LSF) generated by the laser impact line.

FIGS. 10(a)-10(c) are graphs showing signals as the overlap (P) between the LSF and the crack is changed.

### DETAILED DESCRIPTION OF THE INVENTION

The applicants have designed an experimental approach for investigating the application of the LAHUT to detect flaws in railroad axles. The experimental design included consideration of the three primary areas of interest: axle body, wheel seat, and journal. Experiments have been conducted to further refine the application of the LAHUT to the detection of flaws in railroad axles. These experiments investigated different aspects of the LAHUT process: the effects of bulk and surface wave interactions on signal characteristics, the maximum coverage area of a single laser pulse with one receiving transducer, and the effectiveness of detecting cracks in the wheel seat area through the reflection of surface waves. The first set of lab experiments determined if the LAHUT was capable of distinguishing the difference between no-crack and crack conditions.

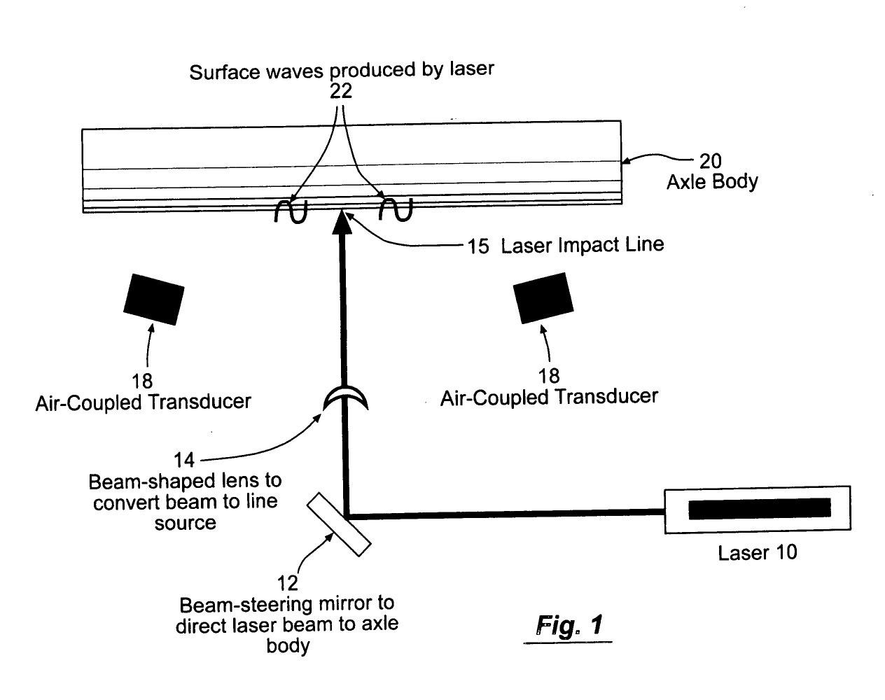

FIG. 1 is a diagram showing one embodiment of the present system for laser application and air-coupled detection of ultrasound in an axle body 20. For example in this embodiment, a laser 10 directs a series of pulses of laser light onto a beam-steering mirror 12, which reflects the pulses though a beam-shaping lens 14 and onto a selected region of the axle body 20. In this specific embodiment, the beam-shaping lens converts the beam to a line source and results in a laser impact line 15 on the axle body 20. The laser pulses generate an ultrasonic signal in the axle body 20 that can be detected by means of a number of air-coupled transducers 18. A line-shaped beam projected orthogonal to the longitudinal axis of the axle body 20 (i.e., parallel to the diameter of the axle body) produces a line-shaped laser sound field 15 that is more effective in propagating surface waves 22 axially along the length of the axle body. However, other beam shapes could be substituted to produce other geometries for the laser impact region.

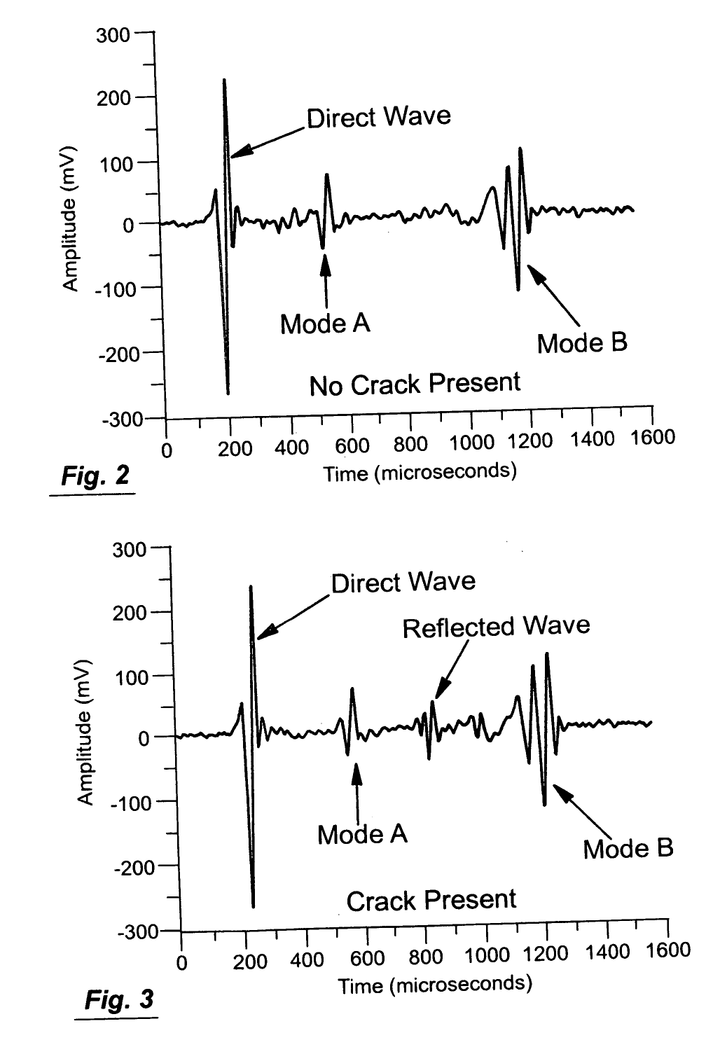

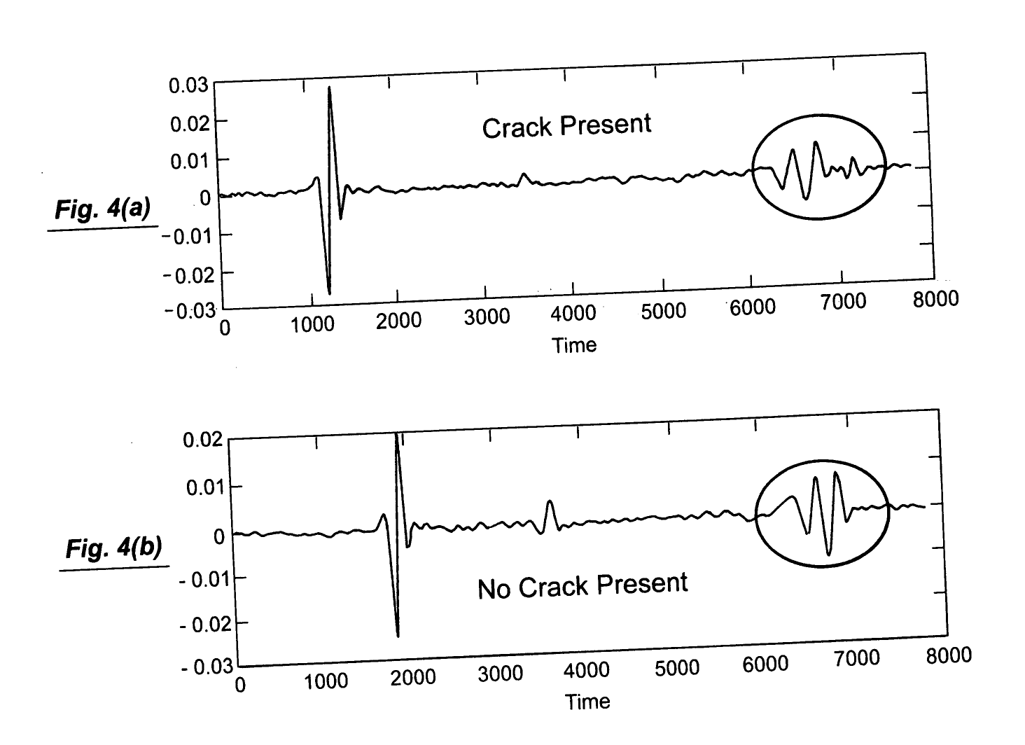

FIGS. 2 and 3 are typical signals from these experiments. Throughout all of these experiments, a 16-inch (406 mm) air gap was maintained between the detecting air-coupled transducers 18 and the axle 20. The surface of the axle 20 was sprayed with water, which would enhance the strength of the laser-generated ultrasonic signal. FIG. 2 shows a sample signal from a no-crack condition with a strong direct surface wave and two other wave modes, (A and B), which are indicative of the geometry of the axle. FIG. 3 is a sample signal from a crack condition showing the arrival of the direct surface wave, the two other wave modes (A and B), and also the reflected surface wave from the crack.

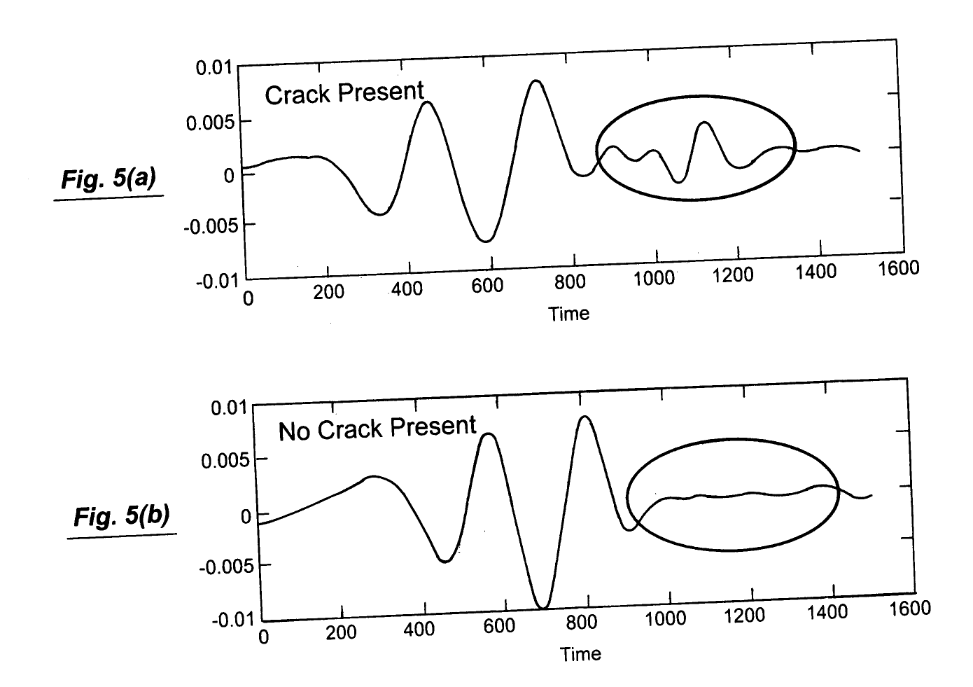

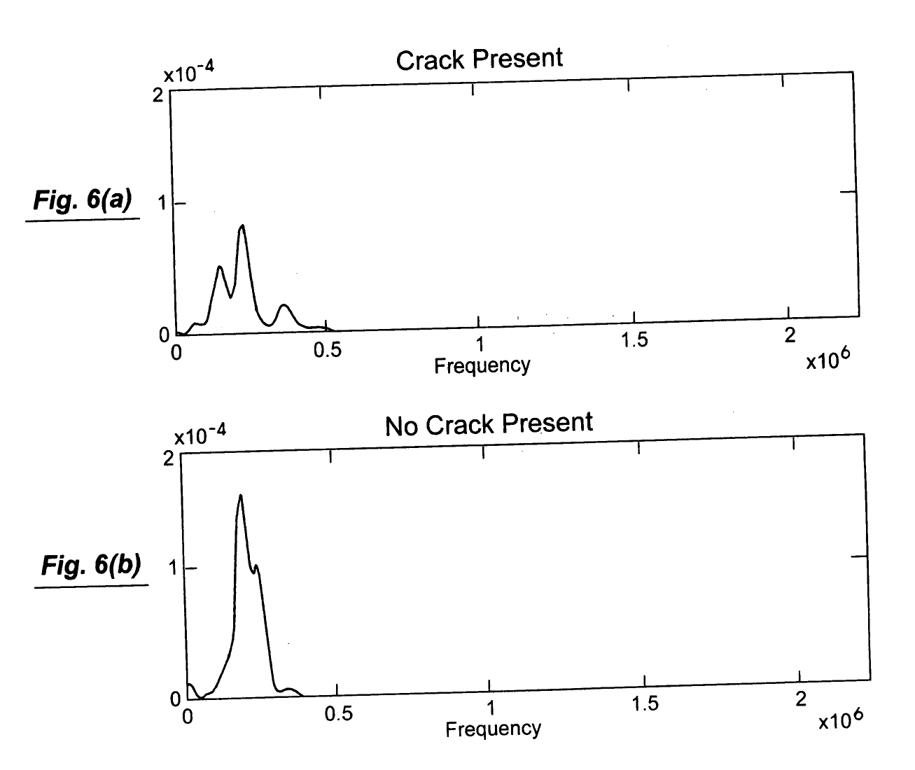

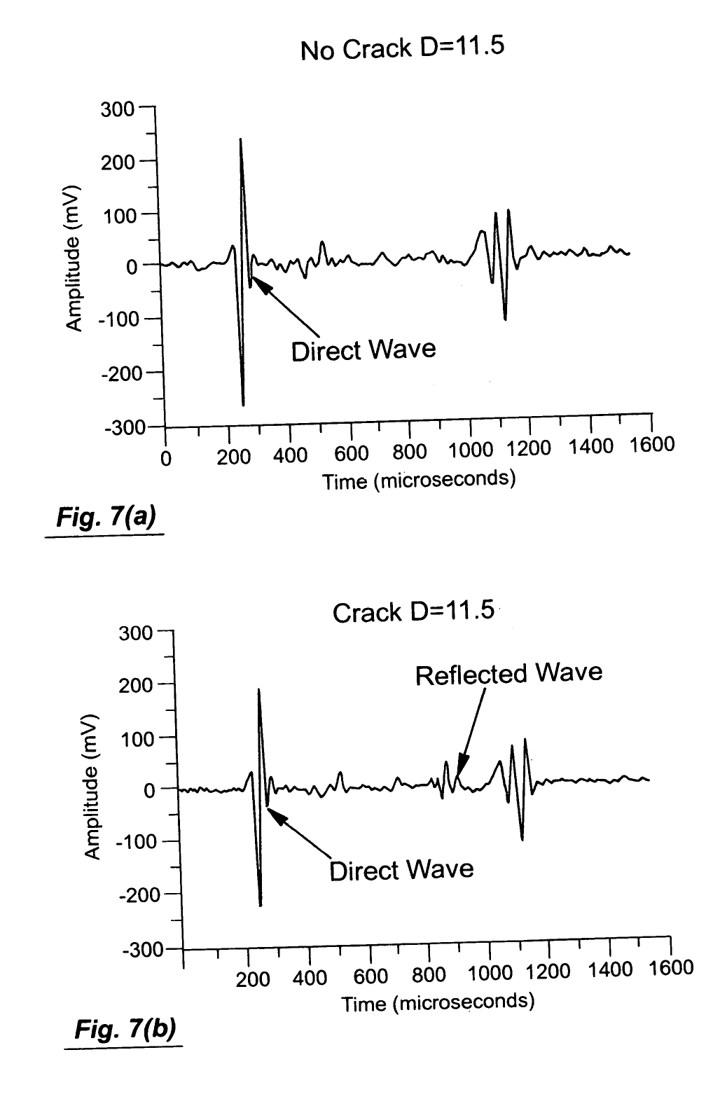

Although the source of waves A and B is still under investigation, many of their characteristics are known and understood. One of the most common features is their distinct and repeatable arrival in time. Experiments were performed to determine the detectability of a reflection from a crack with the same time of flight (TOF) as the waves A and B. To simulate this condition the crack was positioned so that the TOF of the reflected wave would equal the TOF of the more dominant B wave. FIGS. 4(a)-6(b) show the results of these experiments. The raw data in FIGS. 4(a) and 4(b) show a slight but distinct difference between the “No Crack” and “Crack”. conditions. Close-ups of these signals are shown in FIGS. 5(a)-5(b). The graphs of the power spectral density (PSD), provided in FIGS. 6(a)-6(b), reveal the higher frequency content of the reflected wave. The crack, in this case, acts as a filter by allowing low-frequency components of the direct wave to transmit through the crack. High-frequency components are reflected back and received by the same transducer that captured the direct wave. The TOF difference between the direct and reflected waves can be used as a very precise indication of the location of the crack.

The second set of LAHUT experiments focused on studying the signals effects of changing the distances between the crack, transducer, and laser impact line. The axle was illuminated with the laser beam, which was focused to a line and was circumferentially aligned with a crack. While maintaining their vertical and angular positions, the detecting transducers were moved along the length of the axle in 1-inch increments, where 10 data points were collected at each location. The ultrasonic transducers were located 16 inches (406 mm) away from the surface of the axle body and moved horizontally using sliding rods. A cylindrical lens was positioned at its focal length, in this case, 8 inches (203 mm) away from the surface of the axle. The short focal length lens was used for these experiments because the experiment layout needed to be compact to accommodate the lab environment. The distance between the lens and the surface of the axle can be increased by increasing the focal length of the lens (as would be needed in potential wayside applications).

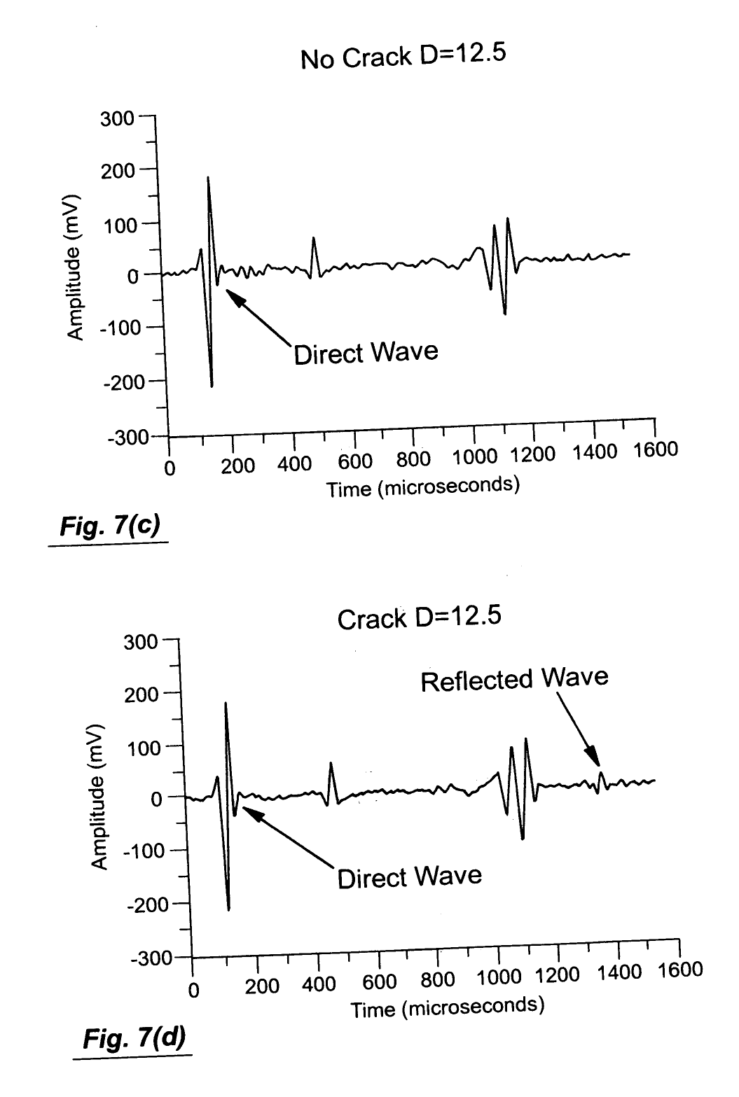

Once the transducer's lateral position covered the entire length of the axle, a new separation distance (D) was selected between the crack and the laser impact line and the experiment was repeated again while moving the transducers along sliding rods. FIGS. 7(a)-7(d) show that a one-inch increase in D increases the TOF of the reflected wave by 8.5 μs, but it does not cause a significant effect on the signal shape or amplitude.

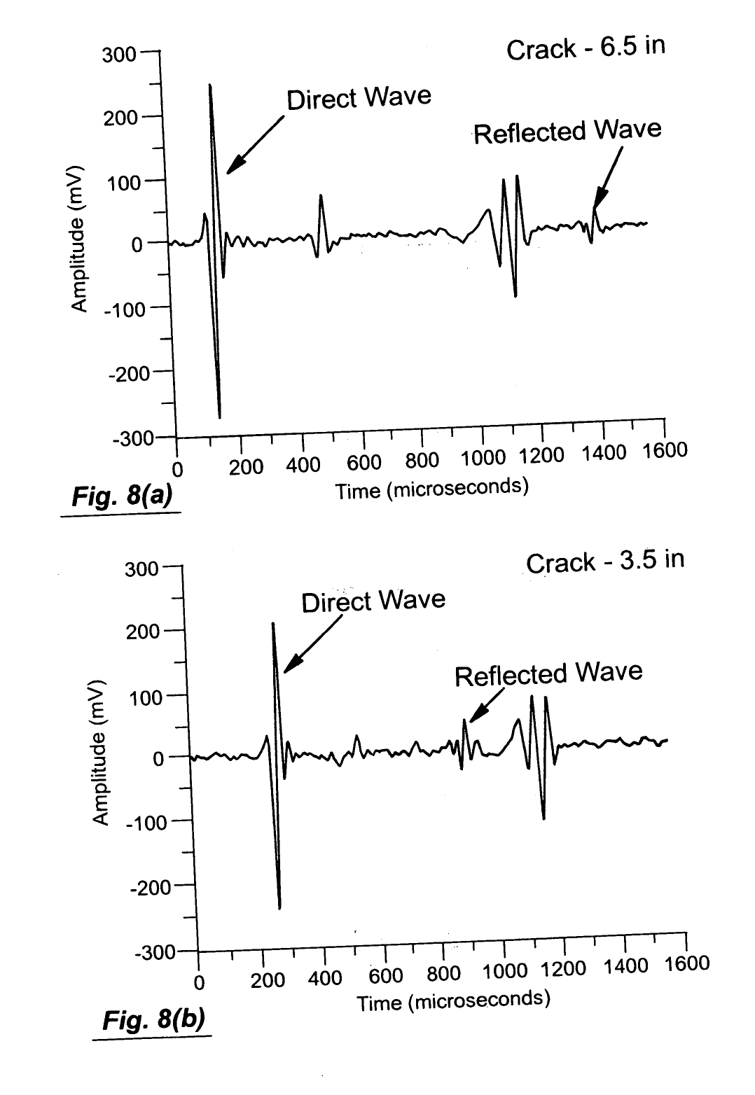

Varying the distance between the transducer and laser impact line produces minimal effects on the acoustic signal. However, as the distance between the crack and the laser impact line (D) increases, the surface acoustic wave spreads away from the illuminated region and diffracts around the crack tips, thus resulting in a reduction in the strength of the reflected wave and an increase in the signal to noise ratio. FIGS. 8(a) and 8(b) show a drop in signal amplitude of the reflected wave for a 3-inch net change in distance between the laser impact line 15 and the crack. The TOF of the reflected wave changes due to the increase in the horizontal distance the wave travels. Two conclusions were drawn from the second set of experiments: The distance between the transducer and laser impact line has minimal effect on signal quality; while the distance D has an adverse effect on detectability.

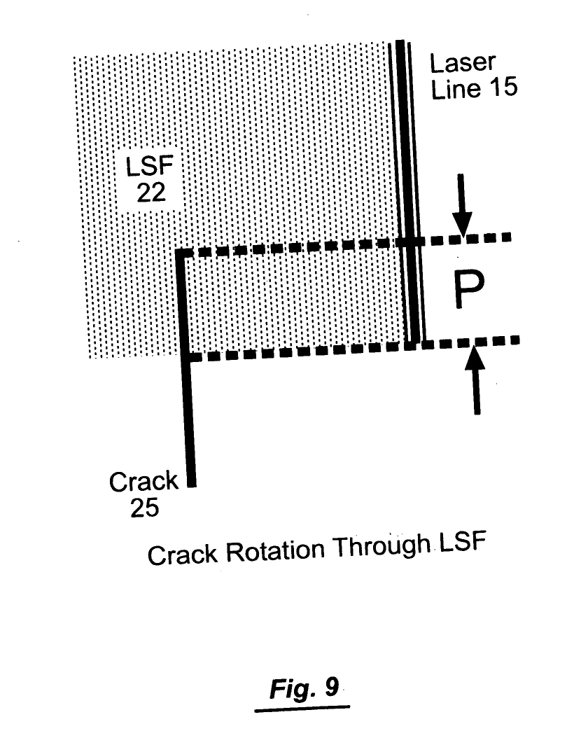

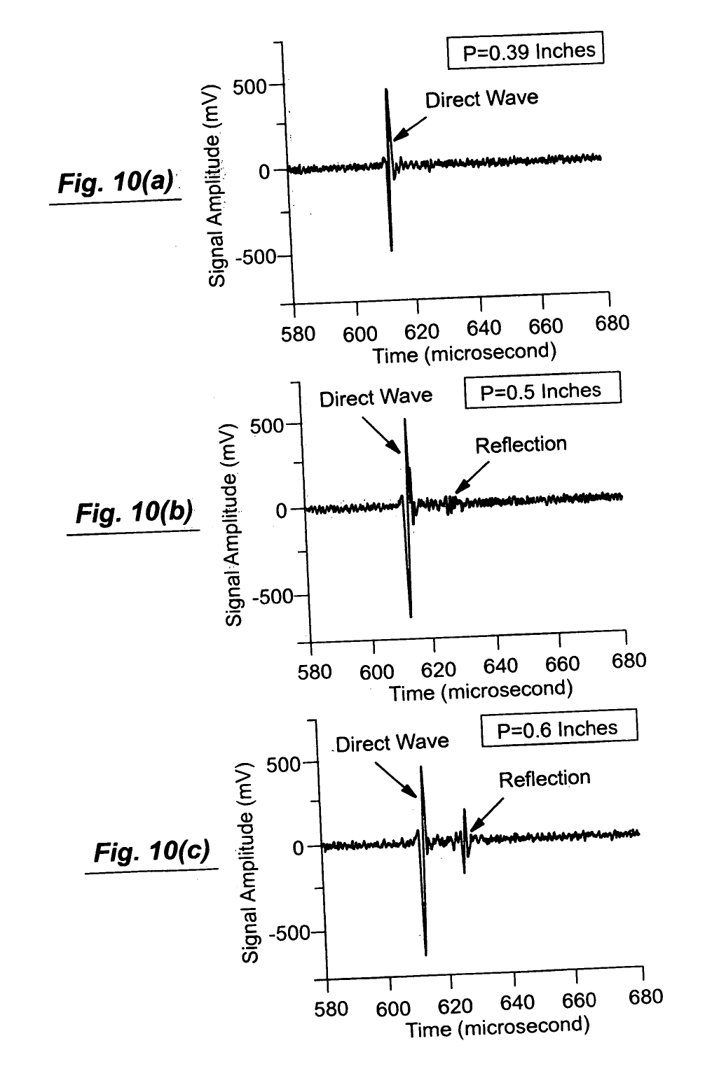

In the third set of experiments, the objective was to find the maximum circumferential coverage length of a single laser pulse with one receiving transducer for the axle body. In order to determine the coverage length, the axle was rotated in small increments to gradually bring the crack in and out of the laser sound field (LSF) generated by the laser impact line. In FIG. 9, the thick triple line represents the laser illuminated region 15 on the axle body, the single line is the crack 25, the shaded area is the LSF 16 and P is the overlap between LSF 16 and the crack 25. As P increases, the detectability of the reflected wave also increases. FIGS. 10(a)-10(c) show data points collected for P-values between 0.39 and 0.6 inches. At the conclusion of these experiments, it was found that an overlap of at least 0.4 inch is necessary in order to reliably detect a 2-inch surface defect.

Finally, preliminary experiments have been performed to detect axle cracks in the wheel seat area. No wheel was mounted on the axle or loads applied to simulate the stresses and constraints of a pressed wheel. In these experiments, the laser illuminated region and the transducer were both located near the body-wheel seat radius. The results indicate that defect detection is possible in the wheel seat area, but further research is necessary in order to validate this technique under loaded conditions and with a wheel mounted. Signal processing included analysis such as time of flight, wavelet transform, and fast Fourier transform were used to program preliminary automated detection algorithms.

Proof of Concept (POC) Demonstration. Completion of the initial phase of laboratory research was followed by a POC demonstration to determine if the application of the LAHUT is feasible in a dynamic wayside application. This feasibility test included the inspection of the body of six test axles. All axles were characterized and documented using conventional NDT techniques prior to the test. The techniques included visual inspection, dye penetrant testing, magnetic particle testing, and conventional ultrasonic inspection. The results of the NDT characterizations were documented and used for verification during data analysis. The test set consisted of six axles: three axles with no defects, one calibration axle, and two axles with service induced defects. The calibration axle contained three 2-inch saw cuts located at various locations along the axle body. The saw cut locations were selected to test the technique for typical crack conditions, long distances between the laser impact line and the crack, and for reflections from a crack overlapping with the other wave modes discovered during laboratory investigations. The service induced defects ranged in size between 1.25 inches and 1.75 inches.

Wheelsets were rolled through an inspection station at walking speeds. The station consisted of a series of laser beam steering/focusing components and receiving transducers. The ultrasonic transducers were placed below the top of rail and near the wheel seats of the axle. All other equipment, with the exception of the optics, was located on the field side of the rail. The laser beam was focused to a 0.75 inch line and illuminated the center of the axle body. Water was applied to the axles before entering the inspection zone to increase the strength of the laser generated acoustic signal. Static and dynamic data was collected on a digital oscilloscope for each axle. During static testing, the air gap was decreased to increase the signal to noise ratio and the crack was positioned to obtain maximum overlap P between the crack and the LSF. Results from the static tests were only used as a comparison for the dynamic data and are not included in any of the POC results. During dynamic testing the crack position was aligned with the LSF before the axle passed the inspection station. As the axle passed through the inspection station, data was collected and stored by the digital oscilloscope. Each test was repeated 10 times or more.

Developmental MatLAB algorithms were constructed for post-test data analysis. The algorithms used basic filtering and enveloping techniques to verify if a crack was present. Comparing the results produced by the algorithms to actual characterization data shows that 88% of the defects were detected with only one false positive in 41 opportunities. The table below is a summary of the results produced by the algorithms for each crack according to crack type and size. Saw cuts and service induced flaws are indicated by crack type “A” and “S”, respectively.

| | Crack | Crack | | Total | Total | Cracks | Alpha |
|---|---|---|---|---|---|---|---|
| Crack # | Type | Size | | Passes | Cracks | Detected | Error |
| 1 | A | 2 | in | 47 | 47 | 44 | 94% |
| 2 | A | 2 | in | 40 | 40 | 38 | 95% |
| 3 | A | 2 | in | 40 | 40 | 29 | 73% |
| 5 | S | 1.75 | in | 60 | 60 | 50 | 83% |
| 6 | S | 1.25 | in | 19 | 19 | 19 | 100% |

| | | | | | | |
|---|---|---|---|---|---|---|
| no | no crack | n/a | 41 | 0 | 1 | n/a |

Both cracks #3 and #5 show a noticeable decrease in detectability. Crack #3 is a saw cut near the wheelseat area and, therefore, is located at a relatively long distance from the laser source. Similar effects were observed in the lab when the distance D was increased, as discussed earlier. Crack #5 is located on an axle which contained instrumentation from another test that could not be removed. The instrumentation was located directly in the path of the surface wave propagation between the laser impact line and the crack causing adverse affects on test results.

Other sources of error included the ability to precisely align the LSF with the crack to maximize the overlap P. In some cases, the overlap P dropped below the minimum threshold for reliable detectability. This was due to the response of the wheel position sensors, which triggered the laser, and the speed at which the wheelset was rolled through the inspection station.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A system for ultrasonic inspection of railroad axles comprising:
a laser projecting a series of pulses onto a laser impact region of a railroad axle to create an ultrasonic signal propagating along the surface of the axle;
an air-coupled detector receiving the ultrasonic signal at a position on the axle spaced apart from the laser impact region; and
a processor analyzing the ultrasonic signal detected by the air-coupled detector for the presence of a reflected wave indicating the presence of a defect in the axle.

2. The system of claim 1 wherein the processor detects the presence of a reflected wave at least in part by its higher frequency content.

3. The system of claim 1 wherein the processor calculates the location of the defect as a function of the difference in the time of flight of the reflected wave and the time of flight of a direct wave from the laser impact region.

4. The system of claim 1 wherein the laser source is focused to a line.

5. The system of claim 4 wherein the line is orthogonal to the longitudinal axis of the axle.

6. A method for ultrasonic non-contact inspection of moving railroad axles comprising:
remotely projecting a series of laser pulses from a stationary location onto a laser impact region of a railroad axle to create an ultrasonic signal propagating along the surface of the axle;
remotely receiving, from a stationary location, the ultrasonic signal in an air-coupled manner at a position on the axle spaced apart from the laser impact region; and
analyzing the detected ultrasonic signal for the presence of a reflected wave indicating the presence of a defect in the axle.

7. The method of claim 6 wherein the presence of a reflected wave is detected at least in part by its higher frequency content.

8. The method of claim 6 wherein the laser source is focused to a line.

9. The system of claim 8 wherein the line is orthogonal to the longitudinal axis of the axle.

10. The method of claim 6 further comprising the step of calculating the location of the defect as a function of the difference in the time of flight of the reflected wave and the time of flight of a direct wave from the laser impact region.
